(19) United States
(12) Patent Application Publication
(10) Pub. No.: US 2018/0164605 A1
(43) Pub. Date: Jun. 14, 2018

(54) CONTACT LENS AND METHOD FOR MAKING THE SAME

(71) Applicant: HON HAI PRECISION INDUSTRY CO., LTD., New Taipei (TW)

(72) Inventor: HSIU-WEN CHIEN, New Taipei (TW)

(21) Appl. No.: 15/490,497

(22) Filed: Apr. 18, 2017

(30) Foreign Application Priority Data
Dec. 10, 2016 (CN) 201611134170.4

(51) Int. Cl. G02C 7/04; B29D 11/00

(52) U.S. Cl. CPC G02C 7/049; B29K 2083/00; B29D 11/00317; B29D 11/00134

(57) ABSTRACT

A contact lens comprises a lens substrate. The lens substrate comprises an inner surface, and an outer surface facing away from the inner surface. The lens substrate further comprises a pupil region, and an annular iris region surrounding the pupil region. The inner surface comprises a first area corresponding to the iris region. The contact lens further comprises a pattern portion formed on the first area. The pattern portion comprises a plurality of nanostructures spaced from each other. Each nanostructure protrudes from the inner surface. The nanostructures and the lens substrate are made of a same material. The disclosure also provides a method for making a contact lens.

### FIELD

The subject matter herein generally relates to a contact lens and a method for making the contact lens.

### BACKGROUND

Contact lenses are commonly worn by users to correct vision, or for cosmetic or therapeutic reasons. Since the contact lens directly contacts eyes of the user when in use, the contact lens needs to match the eyes in shape.

### BRIEF DESCRIPTION OF THE DRAWINGS

Implementations of the present technology will now be described, by way of example only, with reference to the attached figures.

FIG. 1 is a diagrammatic view of an exemplary embodiment of a contact lens.

FIG. 2 is a cross-sectional view of the contact lens taken along II-II line of FIG. 1.

FIG. 3 is an enlarged cross section of circled portion III of FIG. 2.

FIG. 4 is similar to FIG. 3, but showing another exemplary embodiment of a contact lens.

FIG. 5 is similar to FIG. 3, but showing yet another exemplary embodiment of a contact lens.

FIG. 6 is a flowchart of an exemplary embodiment of a method for making a contact lens.

FIG. 7 is a cross-sectional view of a mold used to make the contact lens of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to illustrate details and features of the present disclosure better. The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean at least one.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” when utilized, means “including, but not necessarily limited to”; it specifically indicates open-ended inclusion or membership in the so-described combination, group, series and the like.

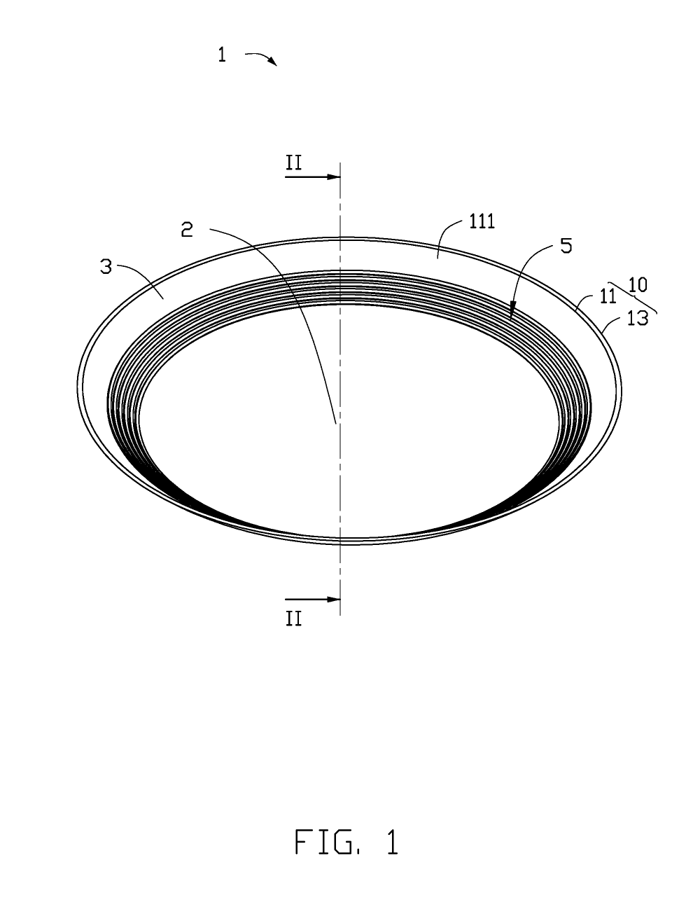

FIGS. 1-3 illustrate a first exemplary embodiment of a contact lens 1. The contact lens 1 comprises a lens substrate 10. The lens substrate 10 comprises an inner surface 11 and an outer surface 13 facing away from the inner surface 11. The inner surface 11 is concave. The outer surface 13 is convex. When in use, the inner surface 11 contacts an eye of a user.

The lens substrate 10 further comprises a transparent pupil region 2 and a substantially annular iris region 3 surrounding the pupil region 2. The pupil region 2 is substantially circular.

The inner surface 11 comprises a first area 111 corresponding to the iris region 3.

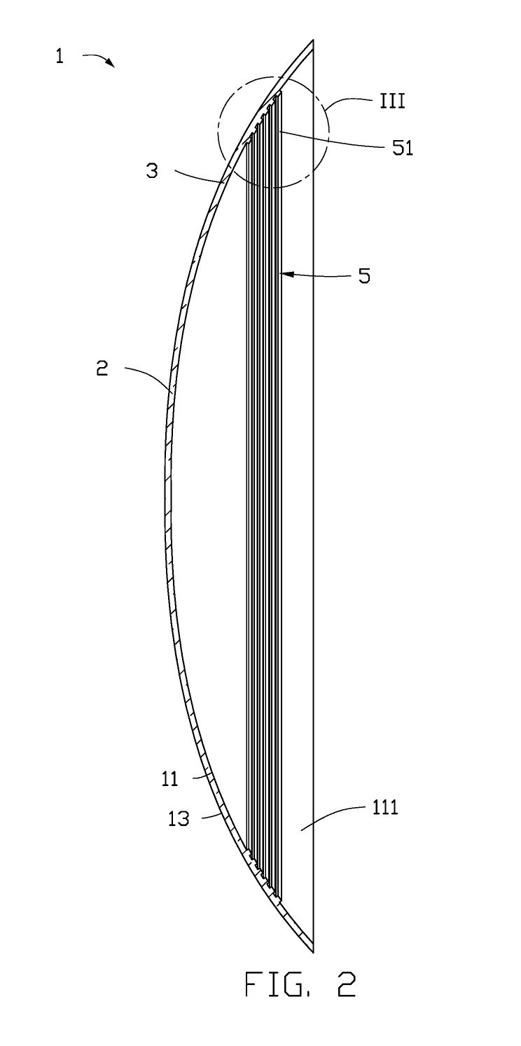

A pattern portion 5 is formed on the first area 111 and surrounds the pupil region 2. Referring to FIG. 2, the pattern portion 5 comprises a plurality of nanostructures 51. The nanostructures 51 are spaced from each other. An area of the pattern portion 5 is less than or equal to an area of the first area 111. Each nanostructure 51 protrudes from the inner surface 11. The nanostructures 51 and the lens substrate 10 are made of a same material.

In the exemplary embodiment, the lens substrate 10 and the nanostructures 51 are both made of hydrogel or silicone hydrogel. The hydrogel or the silicone hydrogel is soft and can be elastically deformed so that each nanostructure 51 can also be elastically deformed according to a radian of the cornea of the eye when the contact lens 1 is worn on the eye. The nanostructures 51 can have different degrees of deformation for corneas which have different radians. Thus, the contact lens 1 can closely contact the corneas to allow the user to feel more comfortable.

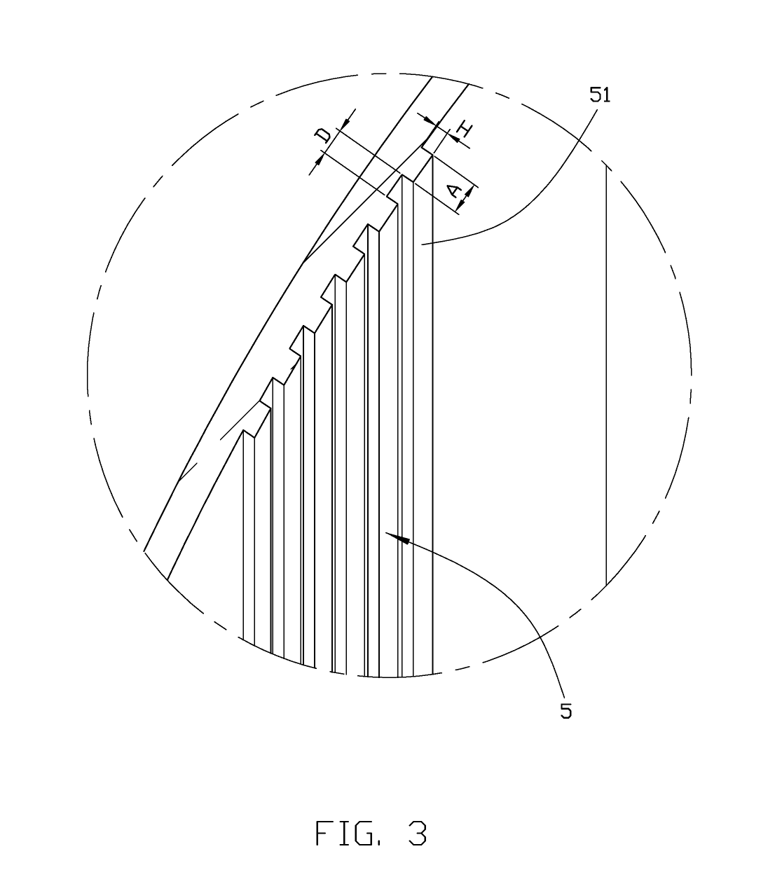

Referring to FIG. 3, in the exemplary embodiment, at a cross section of the contact lens 1 passing through a center of the contact lens 1, each nanostructure 51 has a width (labeled as “A”) of about 50 nm to about 500 nm, and has a height (labeled as “H”) of about 5 nm to about 500 nm. A distance between two adjacent nanostructures 51 (labeled as “D”) is about 50 nm to about 500 nm.

The shape of the pattern portion 5 may be varied. The nanostructures 51 cooperatively form at least one first annulus concentric with the pupil region 2.

In the first exemplary embodiment, each nanostructure 51 is a single first annulus concentric with the pupil region 2.

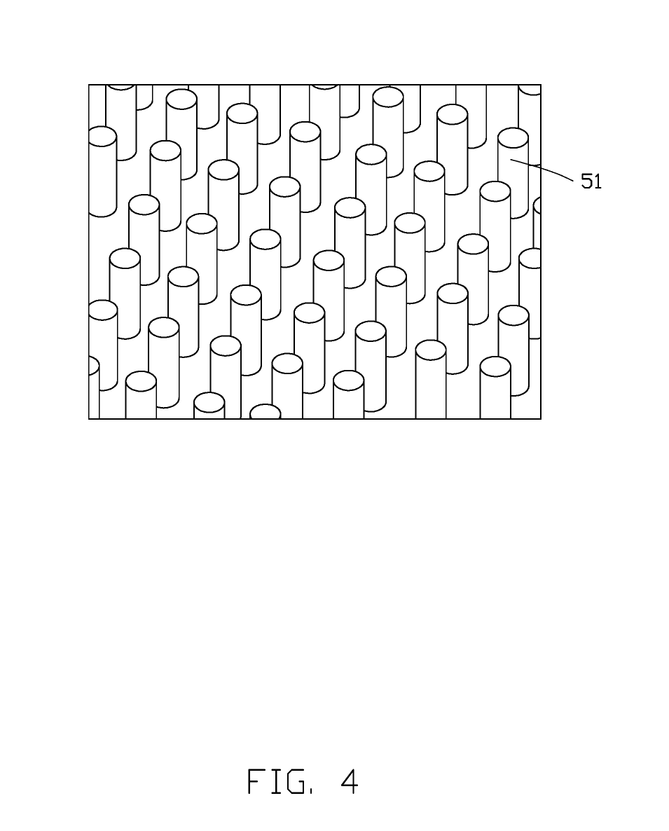

Referring to FIG. 4, in a second exemplary embodiment, each nanostructure 51 is a cylinder. A plurality of cylinders cooperatively forms at least one second annulus surrounding and concentric with the pupil region 2.

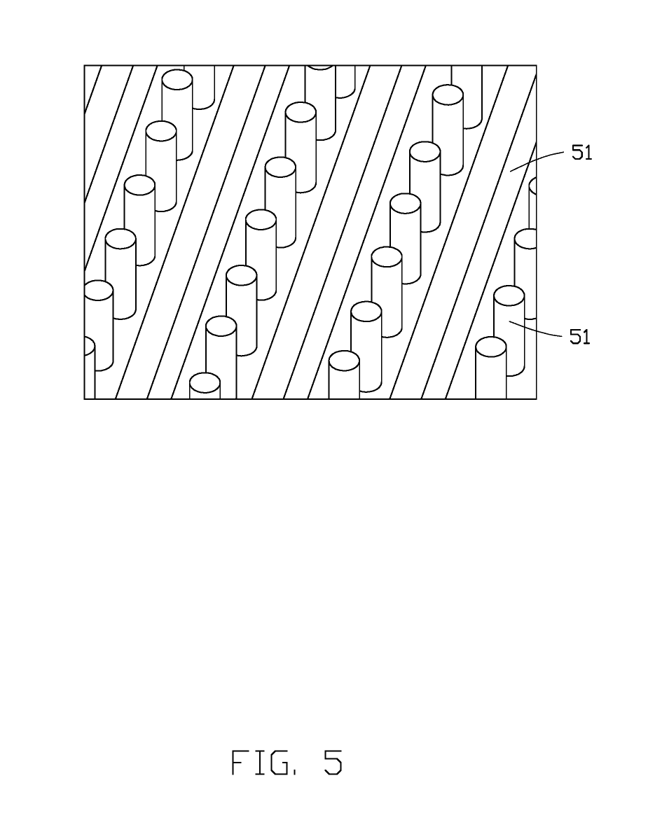

Referring to FIG. 5, in a third exemplary embodiment, the nanostructures 51 comprises at least one first annulus and a plurality of cylinders. Each first annulus is concentric with the pupil region 2. A plurality of cylinders cooperatively forms at least one second annulus surrounding and concentric with the pupil region 2. The first and the second annuluses are alternately arranged and spaced from each other.

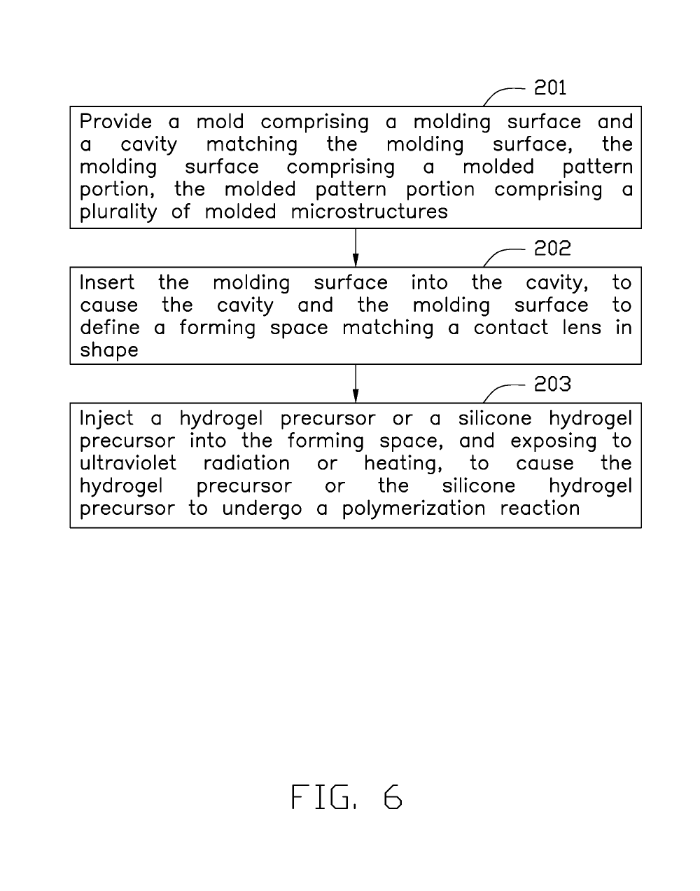

FIG. 6 illustrates a flowchart of an embodiment of a method for making a contact lens 1 in accordance with an exemplary embodiment. The exemplary method is provided by way of example, as there are a variety of ways to carry out the method. Each block shown in FIG. 6 represents one or more processes, methods, or subroutines, carried out in the exemplary method. Furthermore, the illustrated order of blocks is by example only, and the order of the blocks can change. Additional blocks may be added, or fewer blocks may be utilized, without departing from this disclosure. The exemplary method can begin at block 201.

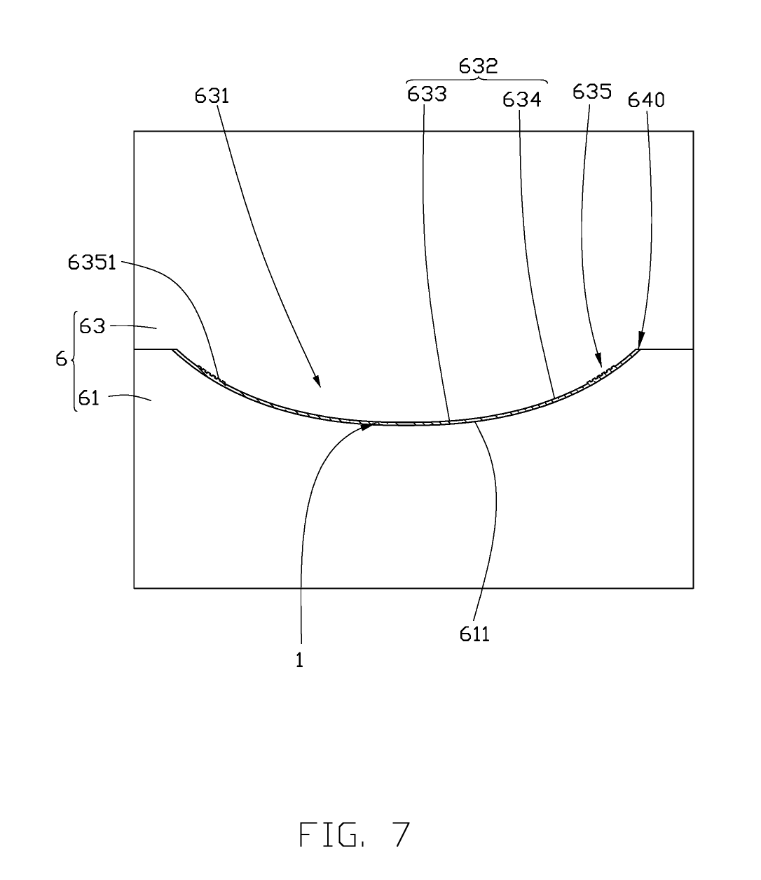

At block 201, referring to FIG. 7, a mold 6 is provided which comprises a female die 61 and a male die 63 matching the female die 61. The female die 61 comprises a cavity 611. The male die 63 comprises a mold core 631 protruding toward the female die 61 and matching the cavity 611.

The mold core 631 comprises a molding surface 632 protruding toward the female die 61. The molding surface 632 comprises a substantially circular first molded area 633 and a substantially annular second molded area 634 surrounding the first molded area 633. A molded pattern portion 635 is formed on the second molded area 634.

The molded pattern portion 635 surrounds the first molded area 633. The molded pattern portion 635 comprises a plurality of molded nanostructures 6351. The molded nanostructure 6351 are spaced from each other and recessed from the molding surface 632.

In at least one exemplary embodiment, at a cross section of the molding surface 632 passing through an apex of the molding surface 632, each molded nanostructure 6351 has a width of about 50 nm to about 500 nm and has a depth of about 5 nm to about 500 nm. A distance between two adjacent molded nanostructures 6351 is about 50 nm to about 500 nm.

The shape of the molded pattern portion 635 may be varied. The molded nanostructures 6351 cooperatively form at least one annular groove concentric with the first molded area 633.

In at least one exemplary embodiment, each molded nanostructure 6351 is a single substantially annular groove concentric with the first molded area 633. In another exemplary embodiment, each molded nanostructure 6351 may be a substantially cylindrical groove. A plurality of cylindrical grooves cooperatively forms at least one annular groove concentric with the first molded area 633.

At block 202, the mold core 631 is inserted into the cavity 611, so that the cavity 611 and the molding surface 632 cooperatively define a forming space 640 matching the contact lens 1 in shape.

At block 203, a hydrogel precursor or a silicone hydrogel precursor used to form the contact lens 1 is injected into the forming space 640, and is exposed to ultraviolet radiation or heated. The hydrogel precursor or the silicone hydrogel precursor undergoes a polymerization reaction, thereby forming the contact lens 1. When the hydrogel precursor or the silicone hydrogel precursor is exposed to ultraviolet radiation, the mold 6 is made of a material which the ultraviolet radiation can pass through.

An outer surface 13 of the contact lens 1 faces to an inner molded surface of the cavity 611. An inner surface 11 of the contact lens 1 faces to the molding surface 632. A pattern portion 5 is formed on a portion of the inner surface 11 corresponding to the pattern portion 635. The pattern portion 5 comprises a plurality of nanostructures 51 each corresponding to each molded nanostructure 6351.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A contact lens comprising:
a lens substrate comprising:
an inner surface comprising a first area, a pattern portion formed on the first area;
an outer surface facing away from the inner surface;
a pupil region; and
an annular iris region surrounding the pupil region;
wherein the first area corresponds to the iris region, the pattern portion comprises a plurality of nanostructures spaced from each other, each nanostructure protrudes from the inner surface, and the nanostructures and the lens substrate are made of a same material.

2. The contact lens of claim 1, wherein the pattern portion surrounds the pupil region.

3. The contact lens of claim 2, wherein the pupil region is circular, and the pattern portion is annular which is concentric with and the pupil region.

4. The contact lens of claim 1, wherein each nanostructure is a single first annulus concentric with the pupil region.

5. The contact lens of claim 1, wherein each nanostructure is a cylinder, and a plurality of cylinders cooperatively forms at least one second annulus surrounding and concentric with the pupil region.

6. The contact lens of claim 1, wherein at a cross section of the contact lens passing through a center of the contact lens, each nanostructure has a width of 50 nm to 500 nm and has a height of 5 nm to 500 nm, and a distance between two adjacent nanostructures is 50 nm to 500 nm.

7. A method for making a contact lens comprising:
providing a mold comprising a female die and a male die matching the female die, the female die comprising a cavity, the male die comprising a molding surface protruding toward the female die, the molding surface comprising a circular first molded area, and an annular second molded area surrounding the circular first molded area, a molded pattern portion formed on the second molded area, the molded pattern portion comprising a plurality of molded nanostructures, each molded nanostructure spaced from each other and recessed from the molding surface;
inserting the molding surface into the cavity, to cause the cavity and the molding surface to form a forming space matching the contact lens in shape; and
injecting a hydrogel precursor or a silicone hydrogel precursor used to form the contact lens into the forming space, and exposing to ultraviolet radiation or heating, to cause the hydrogel precursor or the silicone hydrogel precursor to undergo a polymerization reaction, thereby forming the contact lens.

8. The method of claim 7, wherein the molded pattern portion is annular, and the molded pattern portion is concentric with the circular first molded area.

9. The method of claim 7, wherein each molded nanostructure is an annular groove concentric with the circular first molded area.

10. The method of claim 7, wherein each molded nanostructure is a cylindrical groove, and a plurality of cylindrical grooves cooperatively forms at least one annulus concentric with the circular first molded area.
